(19) United States
(12) Patent Application Publication
(10) Pub. No.: US 2015/0379546 A1
(43) Pub. Date: Dec. 31, 2015

(54) SYSTEMS AND METHODS FOR PROVIDING ADVERSTISEMENTS, COUPONS, OR DISCOUNTS TO DEVICES

(71) Applicant: PCMS Holdings, Inc, Wilmington, DE (US)

(72) Inventor: Riccardo Vieri, Florence (IT)

(73) Assignee: PCMS HOLDINGS, INC, Wilmington, DE (US)

(21) Appl. No.: 14/319,537

(22) Filed: Jun. 30, 2014

(51) Int. Cl. G06Q 30/02

(52) U.S. Cl. CPC G06Q 30/0224; G06Q 30/0239

(57) ABSTRACT

Systems, methods, and/or techniques for providing a digital coupon may be disclosed. For example, a server may distribute or deliver the coupons based on data collected or gathered about a user. The server may have one or more settings that may be used to collect or gather data about the user. The server may apply those settings. The settings may include a source such as asocial network, a device, websites, an application, and/or the like that may be identified and/or may have parameters associated from which the data may be collected. The server may connect to the source based on the settings and may receive data about or for a user from the source. The server may generate a user profile and/or a score associated with the user based on the data and may send a digital coupon to the user based on the user profile and score.

### BACKGROUND

Today, the mobile coupon and/or advertising market is becoming increasingly popular. For example, typical advertising avenues or markets may use, for example, newspapers, paper coupons, mail, and/or the like. Unfortunately, such advertising avenues or markets may fail or not reach its intended goal or target, because users do not take the trouble to actively look at or read an advertisement and/or tend to not be environmentally efficient with the amount of paper used to supply them. As such, offering digital coupons (e.g., via a mobile device such as a cellphone, smart phone, tablet, and/or the like) such as email digital coupons, social media digital coupons, and/or other coupons that may be displayed on a device may be a technique of overcoming such a failure. For example, rather than mass mailings or unfocussed advertising, digital coupons may be tailored or targeted to a customer thereby putting the customer's interest first. At the same time, the digital coupons may be serve a business objective such as increasing sales or enticing new customers. Unfortunately, digital coupons still lack behind print coupons in market usage. Additionally, advertising using such coupon may be imprecise as data used to deliver or provide a coupon to a particular user may not be accurate and/or may not be usable due to privacy considerations.

### SUMMARY

Systems, methods, and/or techniques for providing or distributing promotional materials may be may be provided. In an example, such systems, methods, and/or techniques may provide a digital coupon. For example, a user of a device such as a mobile device may request a digital coupon from a server and may receive the coupon. In an example, a server or other device may be provided to deliver or distribute a digital coupon (e.g., provide the coupons). The server may distribute or deliver the coupons based on data collected or gathered about a user. For example, the server may have one or more settings that may be used to collect or gather data about a user. The server may apply those settings. In an example, the settings may include a source such as asocial network, a device, websites, an application, and/or the like that may be identified and/or may have parameters associated from which the data may be collected. The server may connect to the source based on the settings. The server may receive data about or for a user from the source (e.g., using the settings). The server may generate a user profile and/or a score associated with the user based on the data received and may send a digital coupon to the user (e.g., to his or her device or mobile device) based on the user profile and score. The user may then redeem the coupon at a retailer, for example, using his or her device.

According an example, a device such as a mobile device associated with a user may track information for distribution or delivery of a digital coupon. For example, the device may include an application. The device or the application thereon may render an interface to a user on a display of the device. The interface may be configured to receive data from the user. The device or application may receive the data, for example, via the interface. The device or application may track additional data associated with the user. The additional data may be indicative of one or more characteristics or preferences of the user that may be tracked based on interactions on the device, applications on the device, data or information on the device or used by the device, and/or the like. The device or application may send the data or additional data to receive a digital coupon based thereon. For example, the device or application may send the data or additional data to a server that may distribute or deliver digital coupons such that the server may use the data and/or additional data to generate a profile and/or a score based on the data and/or additional data and may distribute or deliver the coupons using the user profile and/or score.

Further, in an example, a server may be configured at least in part to receive data and additional data. The data may include data received from an input by a user. The additional data may include data tracked on a device of the user. According to an example, the additional data may be indicative of one or more characteristics or preferences of the user determined based on interactions on the device, applications on the device, data or information on the device or used by the device, and/or the like. The server may compare the data and additional data with user profiles already generated and may create a user profile. In an example, the user profile may be created when, based on the comparison, the data or additional data may not be associated with user profiles that already exist. The server may calculate a score for the user profile and may send a digital coupon to the user based on the user profile and the score.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to the limitations that solve one or more disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1 depicts a flow diagram of an example method for providing a digital coupon.

FIG. 2 depicts a block and flow diagram of an example system and method for providing a digital audio coupon.

FIG. 3 depicts a diagram of an example system and/or method for creating data for an advertising campaign using a request form and/or selecting a promotion form.

FIG. 4 depicts example interfaces that may be provided and/or used for with a digital coupon.

FIG. 5 depicts a flow diagram of an example method for providing and/or receiving a digital coupon.

FIG. 6 depicts a system diagram of an example a device such as a wireless transmit/receive unit (WTRU) that may be used to implement one or more of the systems and methods described herein.

FIG. 7 depicts a block diagram of an example device such as a computing environment that may be used to implement one or more of the systems and methods described herein.

### DETAILED DESCRIPTION

A detailed description of illustrative embodiments may now be described with reference to the various Figures. Although this description provides a detailed example of possible implementations, it should be noted that the details are intended to be exemplary and in no way limit the scope of the application.

Systems, methods, and/or techniques for providing or distributing digital advertisement, coupons, or discounts to a device such as a digital mobile device based on information gathered from various sources such as multiple social networks, device preferences and/or usage, and/or the like. In an example, such systems, methods, and/or techniques may provide a creation of a user profile. The user profile may enable and/or be used to deliver a digital advertisement or a digital coupon on the device, for example, through an analysis of information gathered from the user, and compared with what additional information that may be publicly available, for example, on multiple social networks.

The system, methods, and/or techniques herein may improve a return of targeted advertising and, in particular, of digital couponing within the mobile industry by using a user's personal information. For example, personal information of a user of a device may be compared with data that may be stored in a database. The data may be personal identification information (e.g., that may be reliable and/or accurate), geo location information, social information, economic information, credit information, a number of social network a user may be subscribed to, picture information including a number of pictures associated with the user and/or posted by the user, video information including a number of videos posted, friends including a number of friends, search engine popularity, and/or the like. According to an example, the data may include (e.g., may be enhanced or further supplemented with) data gathered from multiple social networks, applications or other information or preferences on the device, and/or the like.

Device advertising such as mobile advertising may be constantly developing and the use of specific applications to provide such advertising may make such a market particularly attractive. According to an example, an application on a device may enable a user to receive and/or benefit from services and information free of charge and in an intuitive way. Furthermore, use of an application may enable a “behavioral style” or preferences of a user to be determined such that categories and/or clusters of similar profiles may be determined or identified. Determining a style or preference of a user may facilitate advertising and/or coupon distribution.

In an example, advertising may be more effective using information that may better reflect one or more characteristics of a targeted user. For example, rather than using generic information, information associated with a particular target user may be used to help facilitate advertising and/or coupons that may be delivered and/or provided to the user. By improving the accuracy of such information and/or using information associated with or specific to a particular user, greater effectiveness and accuracy of advertising campaigns may be achieved.

As described herein, digital advertising or coupons and/or tools that may be used to deliver such advertising or coupons may be imprecise. For example, it may be sufficient for a user to enter general information through the web to trigger the receipt of emails, text messages, audio and video advertising (e.g., to receive digital coupons). Unfortunately, such information may not be verified.

According to an example, an advertising technique such as “behavioral targeting” may be used to help gather information. Unfortunately, such a technique may creating problems for systems and/or methods that may be used to capture the behavioral context of potential targets and, although it may be used, such a technique may generate unnecessary costs for advertisers and lower returns for advertising companies, for example, while being inconvenient for a user.

In particular, the user may be against the use of behavioral advertising, for example, as such information collection may threaten and/or inhibit the user's privacy. For example, data that may currently be collected in such behavior targeting although supposedly anonymized may actually be used to identify real individuals. To help alleviate some of those concerns, advertisers and/or digital coupon providers may police itself as part of its program to monitor and/or regulate data collected and/or tracked online (e.g., as part of behavioral advertising). For example, systems may be provided to defend against to an unwanted collection of user data and/or unsolicited communications. In particular, using current policing techniques and/or systems, a user may click on an unwanted service to easily. For example, using a browser such as an OS browser and touch screen for a device such as a mobile device, the user may accidently click on a pop-up advertisement, banner advertisement, or another service he or she does not wish to be directed to or click on. According to an example, such services being clicked on may result or cause the user to be billed for such services he or she did not wish to receive. Such services being click may also result or cause personal information to be compromised from the sites being browsed by the user.

Further, the internet or current network technologies coupled with devices and systems to defend against unsolicited communications may change advertising such that market share may be gained. For example, device-based or mobile advertising may be growing (e.g., in both scope and relevance) as described herein. Additionally, a diffusion of various systems and/or techniques for “spam” protection (e.g., to help prevent unwanted solicitation) and/or related filters that may shield a user, mass email campaigns may be becoming less and less relevant and redemption rates may be increasingly less attractive. Traditional electronic advertising via banner impressions (e.g., on a search engine site or other website) may also be losing attractiveness, for example, due to lower returns that may be a result of or caused by anti-noise filters that may be present in a browsers including, anti-scripts, anti-popups, and/or the like.

According to an example, contextual advertising may be used. Contextual advertising may provide improved results in terms of redemption rates. Unfortunately, in contextual advertising, the accuracy of user's data that may be used or employed to deliver a targeted advertisement or coupon may not be sufficient and may present challenges in delivering suitable advertisements and/or coupons.

Further, promotional campaigns through paper discounts and coupons from magazines and other publications may be used. Such campaigns may be used and/or migrated to a digital implementation and/or using digital devices. In such campaigns, companies or coupon providers may reward user who spend money at a retailer associated therewith with discounts and coupons. Unfortunately, a small percentage (e.g., 1-2%) of coupons actually generated (e.g., more than 3 billion) may be used. The percentage may improve with the use of digital coupons, viewable and available on devices such as mobile devices and/or with mobile applications (e.g., mobile apps) that may broadened the scope of advertisement and may widen the target audience. However, the provision of improper and/or irrelevant advertisements to non-interested users of particular coupons that may be provided these devices may reduce an effectiveness of marketing campaigns and/or may inhibit privacy of a user by collecting information to provide targeted advertising and/or coupons as described herein.

As such, a system and/or methods associated therewith may be provided. Such a system and/or methods may verify information of a user, for example, without violating privacy such that that advertising and/or digital coupons may be sent to a target audience. The advertising and/or digital coupons that may be sent to the target audience (e.g., a target user) may reduce errors of providing unsuitable advertising and/or coupons to a user and/or may increase an effectiveness of the advertising message.

The system and/or methods may also communicate with various sources of information and may use the information or data from such sources to provide advertisements and/or coupons as described herein. For example, the system and/or methods may gather (e.g., receive) and/or analyze information to multiple sources of information. The information may be received or gathered from the web, from a device of a user, and/or from other sources that may include information associated with a user. Gathering information from sources associated with the user (e.g., sources that may have information about the user) may improve the reliability of the data that may be used to provide advertisements and/or coupons.

The system and/or methods herein may gather or receive such information without relying on user input. For example, the system may receive and/or gather the information itself without a prompt or input from a user (e.g., may receive such information automatically rather than prompting a user to input information about herself or himself). As such, the system may not receive information directly from a user (e.g., by a user entering his or her data voluntarily) in exchange for some benefits, economic or otherwise such as permission marketing, or through use of a mailing list. The system may also increase a return on use of digital coupons and/or advertising.

According to an example, a storage component such as a database may be provided in, on, or in communication with a device such as a server. The database or storage component and/or the device or server may be in communication with external sources such as social networks, one or more external devices such as mobile devices that may include one or more applications, and/or any other information source. The server or device may be queried or triggered by a request such that the server or device may relate to different devices including, without limitation, tablets, mobile devices, computers, and/or the like, access specific information collected and/or provided by the user, and/or may scan the sources described herein for information and/or confirmation of the information collected or provided.

The system and/or device may generate, calculate, and/or assign one or more scores to the information. The scores may be used to determine digital coupons and/or advertising to provide to a user and/or a device such as a mobile device he or she may be using and/or may be used with a profile to determine digital coupons and/or advertising to provide to a user and/or a device of the user. For example, a first score may be determined, calculated, generated, and/or associated assigned to the information. In an example, the first score may be calculated based on or depending on an accuracy and/or veracity of the information collected. A profile may be generated based on the first score or in combination with the first score. Using the first score and/or profile, advertisements and/or digital coupons may be or may not be delivered to a potential target or user. Further, using the first score and/or profile, prices and/or costs for the system to provide the advertisement and/or coupon may change or vary. For example, the more accurate the information provided, the higher the value of the profile may be to coupon or advertising providers (e.g., retailer, and/or the like) and, as such, the cost for such information may vary (e.g., may increase) with increased accuracy of the information and/or with a higher value profile based thereon. Additional scores may further be calculated (e.g., a second score) may be calculated based on the first score and/or additional information or data bout the user that may be collected after the first score may be generated.

According to an example, the information that may be received or gathered may be, without limitation, socio-demographic data, behavioral data, or statistical data. The information may contribute to a creation of a repository (e.g., a robust repository) where a score for each profile may be saved. In an example, the score and/or profile rather than the information or data analyzed or gather may be saved to the repository or storage component to improve or enable privacy of a user's information to be maintained and/or to avoid to the use of personal data for unauthorized purposes.

In an example, the information and/or data may be updated periodically. For example, a system administrator may determine when, how often, and/or how long to scan the sources such as social networks. The system administrator may also determine how to verify changes and/or settings for editing the profile, how to calculate a score and/or whether it may be performed dynamically, and/or any other settings alone or based on the updated information.

The score may also be updated and/or recalculated as described herein. A method of updating and recalculating the score associated with the profile may depend on how up-to-date the information may be. For example, the older or more obsolete the data or information may be, the more the score may be adjusted down or up depending on whether a higher score or lower score, respectively, may indicate a stronger or weaker profile. Adjusting the score based on the accuracy of the data or information may keep a profile marketable and acceptable to advertising or coupon providers.

According to an example, the system or device may create a user profile that may be suitable (e.g., more or less) for being a target for advertising communications on products and/or services that may be delivered (or not delivered if desired) in an order of priority. For example, an user profile may be created based on a number of posts on page associated with the user that may relate to a topic such as sports and that may have a first priority associated therewith, an activity such as traveling that may have a second priority associated therewith, economic information or other information that may have a third priority associated therewith. Such information for the profile may be received or recovered from (e.g., directly) a source such as a social network source as described herein. According to an example, one or more advertisements or coupons may be delivered (or not delivered if desired) based on the first priority, second priority, and/or third priority such that advertisements or coupons related to the topic such as sports may be delivered first or before other topics, activities, or information followed by advertisements or coupons relating to the activity such as traveling having the second priority and the information or economic information having the third priority. In an example, such priorities associated with the user profile may be used to determine whether a user associated with the profile may belong to (e.g., may be active or present) to one or more groups associated with the topic such as a sport's supporter, the activity such as a traveling group on, and/or a member of a group associated with the economic information such as the stock exchange or a trader organization.

In examples, a user profile may be associated with different categories of goods and/or services. For example, a user may frequently purchase a particular good. The system may receive data or information indicative of such a frequent purchase and may associate a user's profile with that good. Advertising and/or coupon providers, in such an example, may be can be charged (e.g., by the system or device) based on an index characterizing the level of affiliation or interest of a specific user to each good or category associated with the good that may be purchased frequently. For example, a user who is present or active on sources such as social networks and may belong to one or more similar groups such as animal defense groups, local animal shelters, and/or the like on those may be determined (e.g., by the system or device) to be receptive to ads relating to animal rights, animal shelters, and/or the like and/or coupons relating pet stores, and/or the like.

The storage component or database that may be created as described herein may be available to an interested party and/or may be centrally run and distributed and/or licensed to an interested third party. For example, the system may grant access to the storage component or database that may include the scores and/or user profiles to a third party. Such access may be direct such that the third part may directly access the storage component or database or indirect such that the system may provide an indication of a user profile and/or score to the third party and/or may facilitate advertisement or coupon deliver on behalf of the third party using the database or storage component.

According to an example, the system or device may provide one or more options for additional information processing and collection including, for example, facial recognition software or applications, an extraction of information or data through photographic analysis, audio analysis, and/or video analysis using an application or “engine,” and/or any other suitable processing that may enable data or information about a user and/or his or her preferences to be received or gathered. For example, one or more photographs on a user's device may be scanned for places the user may frequent, items the user may have, and/or the like and such data or information may be used to help create a profile and/or generate a score as described herein.

As described herein, the system or device may not collect, receive, gather, or store data that may be sensitive. For example, the database or storage component of the system or device described herein may store a score and a user profile generated based on data or information collected, gathered, and/or received not the information or data itself. Additionally, in an example, the system or device may not collect or use particular sensitive information or data such as baking data, health records, financial information, and/or the like.

The system may also search for older versions of personal data no longer available on the sources as part of the information or data it may gather. For example, the system may access archives of information or data of a user that may be provided by a source using virtual machines or other services such that historical versions of websites may be collected and/or existing pages of a site dating back to years ago that were later deleted or modified can be accessed. The system or device may use such information (e.g., if or when available) to update, correct, or enhance the profile and the associated score or points.

According to one example, the system or device may include a server. The server may be connected to the Internet such that the server may analyze one or more profiles. One or more software agents and/or applications may be installed on the server. In an example, each software agent and/or application may provide different functionalities and/or may be aimed at serving different users.

The server may include a control panel to different users. The control panel may provide or enable data profiling and/or classification to be performed. In an example, one or more templates may be provided by the control panel to create a profile. The server may include or be in communication with a database or other storage component included in the system or in communication with the system such that the server may store information or data from a variety of devices, profiles that may be generated, and/or scores or points that may be calculated.

According to an example, a mobile application or device application (e.g., an application) may be provided. The application may be downloaded and/or installed on a device of a user. The application may be in communication with the Internet and/or the system. In an example, the application may be used by the system (e.g., the server) to collect or gather information or data about the user and/or his or her preferences that may be used to generate a profile and/or a score or points. For example, a device may include a smart television (TV). The application may be installed on the smart TV such that the application may collect and/or gather information about television preferences, a typical or preferred time to watch programs, a typical or preferred broadcasting station, typical or preferred transmissions such as business or economic news shows, golf shows, and/or the like. Using such collected or gathered data, a user profile may be generated with a score or points as described herein that may be used to deliver an advertisement or a coupon.

The application may retrieve (e.g., gather or collect) information from other applications on the device; may compare the information or data with data or information stored in a database or storage component on a server; may send the information or data to a server where the server may compare the information or data with data stored in a database or storage component on the server; may scan or search a source such as a social network for information or data related to the user who download the application; may invoke the server to or itself may create an associated profile for the user and/or scores or points associated therewith, and/or the like. The application may be, for example, an application for finding stores or points of interest, a mapping application, and/or the like. The application may receive and/or display on the device advertising messages such as a digital coupon and/or advertisement based on audio and/or video as a function of a user profile (e.g., that may be sent by the server based on the user profile).

In an example, the application may be an application that may deliver digital coupons based on relevant information or data. For example, the application may be used to gather or collect (e.g., including search or scan for) data as described herein. In particular, the use of the application may simplify a collection of information or data present on, or related to, other applications that may be installed on the mobile device, and may it easier for the user to retrieve digital coupons without browsing multiple sites or signing up for different advertisements or coupons. According to an example, through the creation of the application, delivery of advertising materials such as digital coupons or advertisements may be provided by communicating with a browser and/or other applications on the device.

A feature of the system such as the server and/or application may include a search algorithm for information discovery on devices. In an example, the search algorithm may find an item with specified properties among a collection of items (e.g., the search algorithm may find particular pieces of information from a collection of information that may be used to generate a user profile and/or a score or points as described herein). The items may be stored individually as records in the device memory, may be elements of a search space defined by a mathematical formula or procedure, such as the roots of an equation with integer variables, and/or may be a combination thereof. According to an example, the search algorithm may search for, look for, or determine a specific sub-structure of a given discrete structure such as a graph, a string, a finite group, and/or the like to determine information, items, or data that may be used for a user profile and/or a score or points as described herein. For example, the search algorithm may be string matching oriented and may find a place where one or several strings and patterns may found within a larger string or text to determine an item, data, and/or information of interest (e.g., that may be used with a user profile and/or a score or points as described herein). According to an example, using one or more programming languages such as Java, Visual Basic, C#net, C++, flash, and/or the like, an application that may be designed to display digital coupons and discount offers may be modified and/or may be able to scan other applications on the device and store or use the collected data such that a profile and an associated score may be created as described herein.

The system such as the server and/or application may also interact with a browser extension such as Safari, Opera, Chrome, Android, Dolphin, Blazer, Kindle, and/or the like. For example, a browser extension may be downloaded and/or installed on the device of the user. (e.g., by the user or pushed to the device by the server or another entity). In an example, the browser extension may collect information or data, may send it to the server, may compare it with available data that may present via a source such as a social networks may create and/or facilitate creation of a user profile and/or a score or points associated therewith, and/or the like as described herein. One or more browser extensions may be provided and/or used. According to an ex can be very useful because it would also allow the user to filter the advertising information that may be received. In one exemplary embodiment, a user downloads a browser that acts as an anti-ads filter, and allows the user to receive only ads that have been pre-filtered.

As described herein, to receive digital coupons or advertisements, a user may fill out a form such as a digital coupon request form on his or her device. The device may be connected to a network such as the Internet, an Intranet, a wireless communication network, and/or the like. The user may fill out the form using a browser associated with the network or through a dedicated application installed on the device. The information or data in the form may be provided to a server as described herein and may be used to create and/or update a user profile and/or calculate or update a score or points associated with the user profile. According to an example, the form may collect from the user a name, a surname, an email address, and/or any other information or data about the user. The user may select an option to submit the form after inputting or entering his or her information or data. The data or information may be received at a server that, on the basis of the transmitted information, may access a storage component or a database and may verify an existence of a profile for the user (e.g., a user profile). If there may not be such a profile, the server (e.g., via a routine, instructions, or method executed thereby) may scan a source such as the Web, a social network, a device of the user, and/or the like and may receive information or data about the user form the scan or search. The server may compare the information or data submitted by the user with the information or data from the scan. A profile may be created based on the information or data including the information or data submitted by the user and the information or data gathered or collected from the scan or search. In an example (e.g., if the person turns out to be present on a social network or other source), a profile may be created and a score calculated on the basis of values associated with characteristics of the user's profile and an alignment with the campaign that may be set up by an advertiser or entity. As described herein, the profile may be more reliable and verifiable by using such information or data. In an example, the reliability of the profile may correlate or correspond to a cost that may be provided to an advertiser or entity to use the system such as the server. For example, the more reliable and verifiable the profile may be, the more it may cost an advertisers to send digital coupons or advertisements to a user of the profile using the system such as the server.

According to an example, the score or points may be calculated as a sum or another function of a series of numerical values that may be assigned to aspects of the user profile and/or the data or information used to generate the user profile. Each numerical value may correspond to different characteristics of the user's data or information and/or profile created therefore. For example, a user may submit a form online and may include an email address, a city, and/or his or her sex. The system and/or application may receive the email address, city, and/or sex (e.g., via the form), may scan sources such as the web or a social network scan verify the information may be present and/or correct, and may assign points to the email address, city and/or sex. For example, the system and/or application may assign a first number of points such as three points for the email address (e.g., which may be more important because it may be a more specific piece of information about the user), a second number of points such as two points for the sex (e.g., which may be less important than some information like the email address but more important that other information as it may define a correct category to address specific offers to the user), a third number of points such as one point for the city and geolocation (e.g., which may be more important than some pieces of information but less important than other pieces of information such as the email address and/or sex as it may be used to target a specific local ad). The points such as the first, second, and third number of points may be added together to calculate and/or generate a score for the user profile according to an example described herein.

As such, in an example, particular characteristics or pieces of the information or data may be weighted with a higher value than other characteristics or pieces of the information or data and/or may be valued more than other characteristics or pieces of information. For example, pieces of the information associated with higher spenders may be weighted with a higher value than other pieces of information associated with a lower spender. In particular, according to an example, personal information for the user may be scanned and verified from sources such as the web or a social network as described and the scanned verified information may indicate that the user may play a particular sport such as golf that may have higher points associated therewith, may have a particular credit card or financial instrument that may have higher points associated therewith, may visit or stay in prestigious hotels that may have higher points associated therewith, and/or the like. These higher points may identify the user as a “higher spenders” and/or may indicate the user may have a higher likelihood of using particular offers or coupons. Other data or information may also be used including personal identification like age, zodiacal sign, sex, city, school, job experience, numbers of people in the family and may be weighted (e.g., higher or lower) in calculating a score according to an example. As such, characteristics or pieces of data valued more may be assigned a higher value than others such that they may contribute more than other characteristics or pieces of information or data to the score (e.g., the final score).

Additionally, as described herein, information or data that may be obtained from a source such as a social network including, but not limited to, groups a user belongs to, types of groups, the number of male friends, the number of female friends, content such as photographs, video, and/or the like, the number of photographs associated with the profile, the number of “tags” in other profiles associated with the user, the type of content, pictures posted, and/or the like. In an example, additional data or information may be created based on the retrieval of such information. Using the information or data (e.g., in combination), a user profile may be generated and/or refined. Such a user profile and/or its refinement may lead to an increase in advertising value of the particular coupons or advertisements that may be provided to a user. For example, advertisement material such as digital coupons or advertisements may be sent to the user (e.g., to his or her device) according to said gathered information.

The system (e.g., the server) may enable a creation of groups of profiles. For example, users who have data and characteristics such as age, hobbies, topics, activities, and/or the like in common may be grouped together.

According to examples, a communication protocol such as Bluetooth, WiFi, and/or the like may be used as a detection tool for acquiring information or data related to a user profile such as existing profiles that may be in a vicinity of the server and/or a device of a user. For example, an application on a device or terminal (e.g., of a user or of a system administrator) may scan for other devices its vicinity that may include sources such as social networking applications that may be installed and available on the devices in the coverage area of the protocol. Such a feature may increase profiles and/or contacts that may be collected by the application on the device through an automatic self-generation of new profiles. For example, in an embodiment, the system and/or the server may include a terminal or device. The terminal or device of the system or server may detect users of devices located within a radius of a terminal that may be associated with the server or system. Information or data may be collected by the terminal using the application. Collected data or information may be sent to the server. Additionally, a device of a user that may have the application thereon may collect information or data from neighboring devices or devices in its vicinity and may provide or send such information to the server for processing including establishing or generating a user profile for those user in the vicinity as described herein.

The system such as the server and/or the application on the device may perform a search for data or information about a user as described herein. For example, a search may be performed or carried out by a system or server administrator via the application installed on a device such as a device of a user. The application may query, through a user interface, selected sources such as social networks that the administrator and/or advertiser may wish to be analyzed and/or may narrow down the search by entering data or information about the selected profiles. According to examples, the applications described herein may be operated by receiving commands via touch interactions and/or via a voice.

In another or additional example, the system can track how many times a profile may be analyzed or accessed. According to an example, the number of times a profile may be analyzed may affect a value (e.g., such as the score or points) of the profile itself. For example, an over-exposed user or a user that may have been accessed several times may end up having a lower or a higher score depending on a campaign set up or established by an advertiser or entity. For example, a campaign administrator may decide to give a higher or lower score to a profile based on the amount of times it may have been accessed and/or the information accessed associated with the profile and may set the profile management settings accordingly. As such, the number of times that a profile is searched and/or accessed may contribute to a score or points associated therewith. The number of times that a profile may be searched and/or accessed may be stored by the server or system in, for example, the storage component or database.

According to examples, transmission of the information or data from a device to the server may be via one or more of the following or a combination thereof: SMS, MMS, email, phone call, Bluetooth message, a touch screen at a kiosk or point of sale, automatic speech recognition (ASR), and/or the like. The transmissions between the server and/or the device (e.g., via the application thereon) may be encrypted using any suitable encryption algorithm or technique such as pretty good privacy (PGP), crypt, data encryption standard (DES), Data Encryption Algorithm (DEA), Rivest-Shamir-Adleman (RSA), digital signature algorithm (DSA), and/or the like.

As described herein, an advertising campaign may be built using a platform of the server. The platform may include forms or templates (e.g., readily available) that may include pre-populated profiles or information or data that may be used to create such profiles.

The system or server described herein may provide advertisements or coupons in real time and/or may adjust a cost to an advertiser based on ratings (e.g., scores or points) associated with a user profile, a type of profile distributed using the user profiles, and/or the like. For example, a company may decide to show a video-coupon. The company may provide the video-coupon to users with a user profile that may have a score, points, or a rating of a particular value (e.g., class 5). The distribution or delivery of the video-coupon by the server may cost a particular amount per view (e.g., two Euros per view), which may exclude other views of the video outside a scope of the campaign.

Additionally, in examples, as the value of the score increases, companies may increase the value of discounts and coupons delivered through the system (e.g., via the server), rewarding customer loyalty for those users (e.g., even though those users may remain anonymous and invisible to advertisers) characterized by a score of a particular value such as a high score (e.g., where such a high score being indicative of truthfulness and reliability of the information provided).

In yet another or additional example, the system or server may take into account whether or not coupons have been used by the users as described herein (e.g., the system may verify a digital coupon). For example, a user may redeem a digital coupon. A score or points of the user profile may be updated on the server to reflect such a redemption. A user who regularly redeems coupons may be determined to be a more reliable client or consumer in the eyes of advertisers and, as such, his or her rating may be updated (e.g., increased or decreases depending on whether a lower or higher score may be deemed as more desirable by an advertiser and/or the system) accordingly.

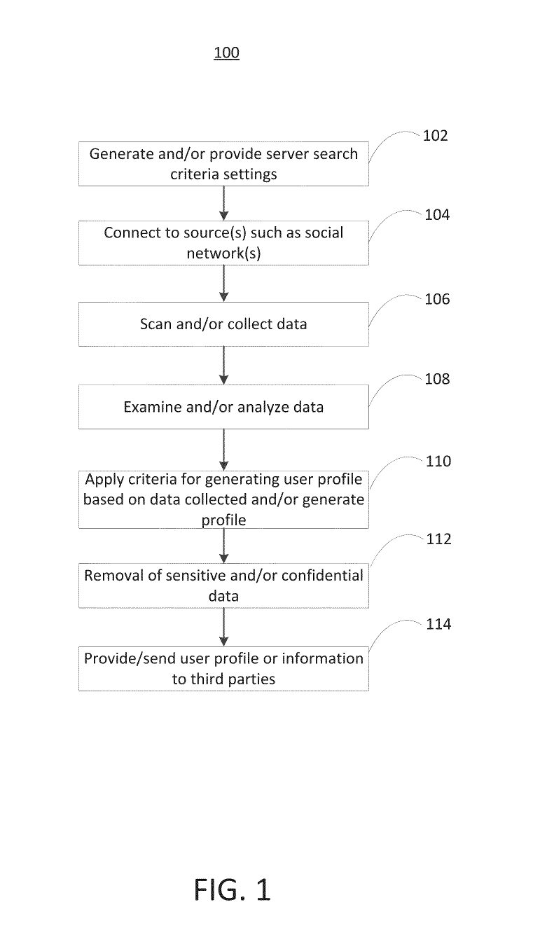

FIG. 1 illustrates a flow diagram of an example method 100 that may be included in a system (e.g., a server) that may be used to distribute and/or deliver digital coupons or advertisements as described herein. As shown in FIG. 1, search criteria settings may be generated and/or provided at 102. For example, at 102, a server in a system may be configured with specific settings to collect and/or gather data from sources such as social networks. According to an example, the settings may include an indication of what sources to connect to, when to connect to such sources, a duration of how long to collect data from such sources, and/or any other suitable indicator on how, why, and/or what type of information and/or data to collect and/or gather.

For example, a server may be configured (e.g., via an interface and/or a dedicated application or software) to scan for, collect, and/or receive data from one or more sources such as a social network source (e.g., Facebook, Twitter, Instagram, and/or the like). The settings (e.g., generated and/or provided at 102) may be configured to enable or cause the server scan such sources for data associated with a particular user profile and/or may indicate particular information to scan for from such sources (e.g., the settings may indicate sources to scan, information and/or data from the sources to scan, and/or the like). The settings may be configured to indicate a time frame in which to scan for such data including a particular time period or a particular periodicity such as once a week during the night. The settings may also indicate a priority or points or a score associated with a source and/or with data or information. For example, the server may assign (e.g., or generate or calculate) a score and points depending on the number of information or data that may be found on such sources related to the particular user profile. Examples of information that may be used to assign points and/or generate, calculate, or create a score may be a verified email address, a verified sex, a verified age, a verified location, and/or the like. The points associated with the information or data and/or how to generate and/or calculate a score for the information may be included in the settings. For example, each piece of the information may have or include a particular number of points associated therewith as described herein that may be indicated in the settings. As described herein, the server may also confirm the user profile and may be configured information or data on pages of a source such as a social network that may belong to a group as described herein. IN an example, the group may be included in the settings. For example, the server may include a list of groups that may be assigned specific points (e.g., based on the settings) such that a user subscribed these groups or topics may be assigned the particular points or more points that a user not subscribed to these groups or topics. In an example, the server may be configured gather or receive as much information as possible from the database (e.g., as indicated or signaled by the settings) and/or the source and such information may be regularly updated confirm the information or data associated with the user profile (e.g., as indicated or signaled by the settings). The database may include additional information or data that may be used (e.g., found, scanned, or gathered) and/or may be assigned different points and/or may have a score including how to calculate the score associated therewith. In an example, the data or information from the database may be used by the server and/or gathered or received thereby, for example, as indicated or signaled based on the settings.

At 104, a connection may be made to a source such as a social network. For example, the server may connect to the sources such as the social networks that may be identified and/or indicated in the settings. In an example, the connection may be made via an interface to the Internet, or another communication network. For example, the server may connect to the source via an interface directly connected to the Internet and/or a communication network such as a cellular network that may provide a connection to the Internet. The server may further, in an example, connect to the source via a device of the user. For example, the device of a user may include information or data to be gathered from source such as a social network (e.g., via an application thereon) and/or the device itself may include preferences and/or other data or information about a user to be collected. The server, at 104, may connect to such a device to gather the data or information.

Data and/or information may be scanned and/or collected or gathered (e.g., received) at 106. For example, the server may scan for data and/or information and/or may collect such data or information at 106. As described herein, the data and/or information may be collected from the sources that the server may connect to at 104. Such sources may include one or more social networks, data or information on a device such as a mobile device of a user, preferences of a user, and/or any other suitable information about a user.

At 108, the data or information may be examined and/or analyzed. In an example, the server may receive the gathered data, at 106, and may examine and/or analyze the data at 108. For example, as described herein, the server may be configured to scan for information or data on a source such as a social network (e.g., at 106). A scan (e.g., a first scan) may recover or receive information or data from a source that may include a particular sex such as male, a particular age group such as 18-21, a particular geolocation such as California, an email address that may be used and/or use of a popular search engine. In an example, such information or data from the scan may be examined and/or analyzed (e.g., to verify accuracy and/or to receive additional information or data associated with a user. In an example, to recover and/or receive an email address at 106 that may be examined and/or analyzed at 108 (e.g., verified at 108), an account may be opened for the score the server may be connected to (e.g., at 104). The server may simulate logging into the source or a mail post such that the server may add contacts from the source at 106 and may examine and/or analyze such contacts at 108. For example, desired information for a user or contact may be verified and founded such that an email address associated therewith may be verified. The same email address may be found on search engines. The system or device may assign points to this profile as verified. In an example, a score of this profile such as a final score may indicate the value of being verified (e.g., may benefit this further value and/or may be higher or lower as desired).

Criteria may be applied for generating a user profile based on the data or information gathered and/or collected and a profile may be generated at 110. For example, the server may apply criteria to the data or information gathered. In an example, the criteria may include a presence of the same information on more than one source such as more than one social network and/or websites. For example, an email address may be recovered (e.g., collected or gathered) from more than one social network and/or from the web (e.g., from a website) social network sites. The email address may be related to a name of a user that may have registered it on the social networks. In such an example, the information (e.g., the email address) may be more reliable and, thus, more points may be assigned to it to generate a profile and/or a score associated therewith. Additional examples of criteria that may be applied may include a sex of a user for which the profile may be generated, an age, range, a location or geolocation, and/or any other suitable characteristic. The server may then generate a profile or user profile based on the criteria applied to the data or information (e.g., based on points of the data or information applied from the criteria). As described herein, the profile may have a score or a number of points associated therewith.

Sensitive and confidential data or information that may have been collected and/or gathered may be removed or discarded at 112. For example, the data or information gathered may include sensitive or confidential data including, for example, a location of a user, one or more user preferences, and/or other data or information the user may wish to be private and/or not shared. The server may use such information or data to generate a user profile (e.g., the server may apply criteria to such data or information and/or may generate a profile based thereon). The server may then discard such information or data such that it may not be subject to hacking or unauthorized retrieval by third parties. For example, after generating the user profile and/or score or points, the server may discard information and/or data that may be sensitive such that the information or data may not be stored by the server and, thus, may not be subject to unauthorized access.

At 114, the user profile and/or the information or data that may not be sensitive may be provided and/or sent to a third party. For example, the server may provide access and/or may send the user profile and/or a score or points associated therewith to a third party such that the third party may use the profile to deliver advertisements and/or coupons to a user. Further, the server itself may deliver or send such coupons or advertisements on behalf of the third party. For example, the server may provide access to the user profile and/or score or points associated therewith. The third party may then select users based on the profile and may either directly send coupons or advertisements thereto or may indicate to the server which user profile it wishes the server to send coupons or advertisements to.

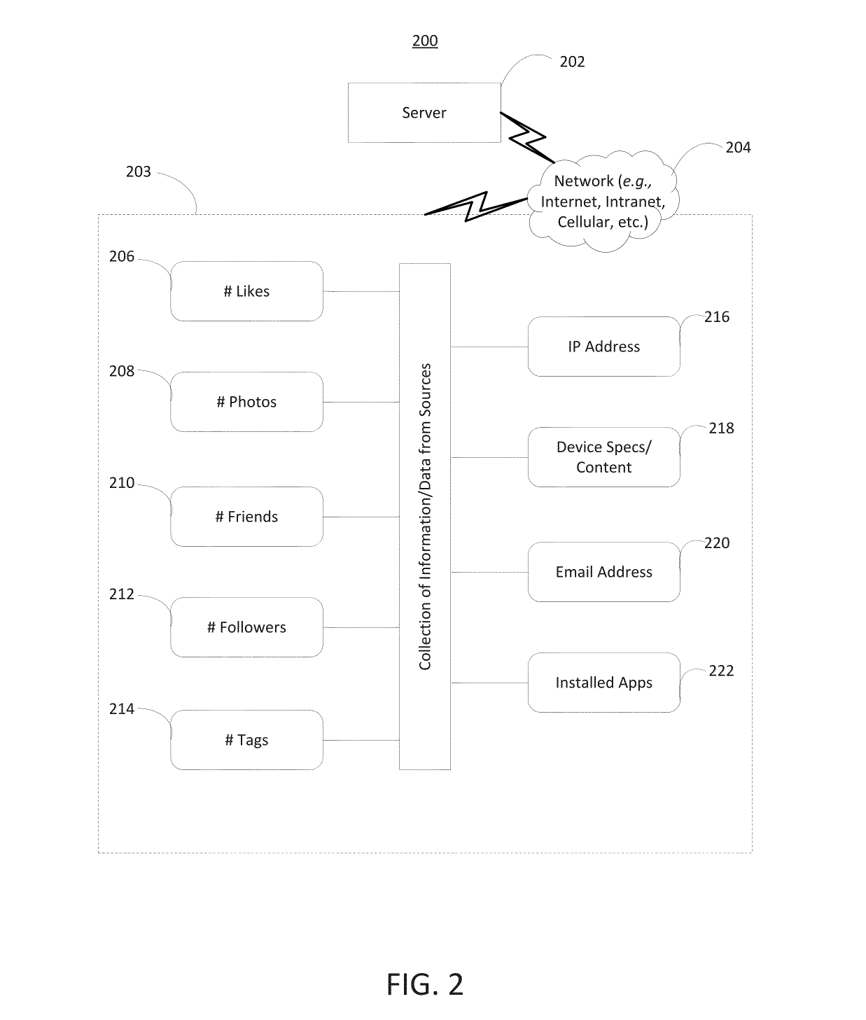

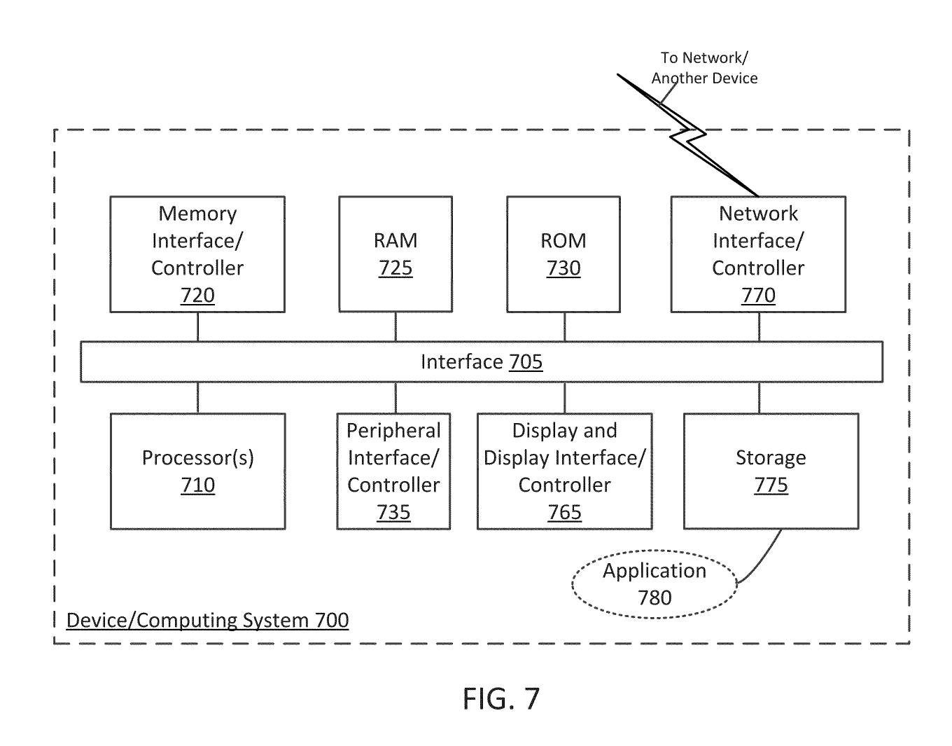

FIG. 2 illustrates a block diagram of an example architecture 200 of a server 202 of a system connected to a source 203 that may be used to provide information and/or data such that coupons and/or advertisements may be delivered based thereon. As shown in FIG. 2, the server 202 may be in communication with the source 203 via a network 204. The network may include the Internet, Intranet, a cellular network, and/or the like. The server 202 may include one or more components such as one or more of the components described in FIG. 7. In an example, the server 202 may include a database or other storage component (e.g., storage component 775 shown in FIG. 7) that may be used to store the information or data, the user profile, and/or a score or points associated therewith.

The source 203 may be a social network, a device of a user, applications that may be used by the user, archived data or information about the user, and/or any other suitable source or provider of information or data about a user. For example, as shown in FIG. 2, the source may include a social network profile including likes 206 associated with the profile such as likes of retailers, goods, services, and/or the like, photographs or content 208 associated with the profile, friends 210 associated with the profile and/or their characteristics, likes, content, and/or the like, followers 212 associated with the profile and/or their characteristics, likes, content, and/or the like, tags 214, and/or any other information or data associated with the source such as the social network. For example, a user profile may have likes associated with particular information or data (e.g., content) such that the profile may be assigned points (e.g., more points or may have points added thereto) based on specific topics such as which groups a user may belongs to, what may be the matters, activities, interests, and/or the like of the groups, and/or the like. In an example, a list of topics may be included in a table in a database associated with the server. Additionally, in an example, if a profile may have more likes in a similar topic on different sources that may be scanned, the number of points associated to the data or information may be increased and the score may include such values. The server 202 may use such the information or data such as the likes 206, photos or content 208, friends 210, followers 212, tags 214, and/or any other information or data associated with the source 203 such as a social network to generate a user profile and/or a score or points associated therewith such that one or more advertisements or coupons may be delivered using the profile and/or score or points.

According to an example, points may be assigned based on the number of friends in a social network. For example, the number of friends a user may have may correspond to or may denote a characteristics of potentially being an influencer. The server may count the number of friends and may assign points thereto based on one or more variables (e.g., when generating a profile). For example, the server may assign 0.05 points from 10 to 100 friends (e.g., to each friend between 10 to 100), 0.07 points from 100 to 250 friends, and 0.10 points from 200 and 500 friends and so on. The same example may be used to a number of pictures taken or on a device of a user or associated with a source of a user and/or the type of pictures. According to an example, these points may have also a negative impact determining the final score. For example the pictures may include abstract items or subjects and not other people or users. In such an example, the server may assign a negative value or points to such information or data and that may be used. The negative points may be used in calculating the score. According to examples, the information or data including points to assign thereto, and/or the like may be included in a table in a database associated with the server and may be assigned via the settings described herein and/or by an administrator of the system associated therewith.

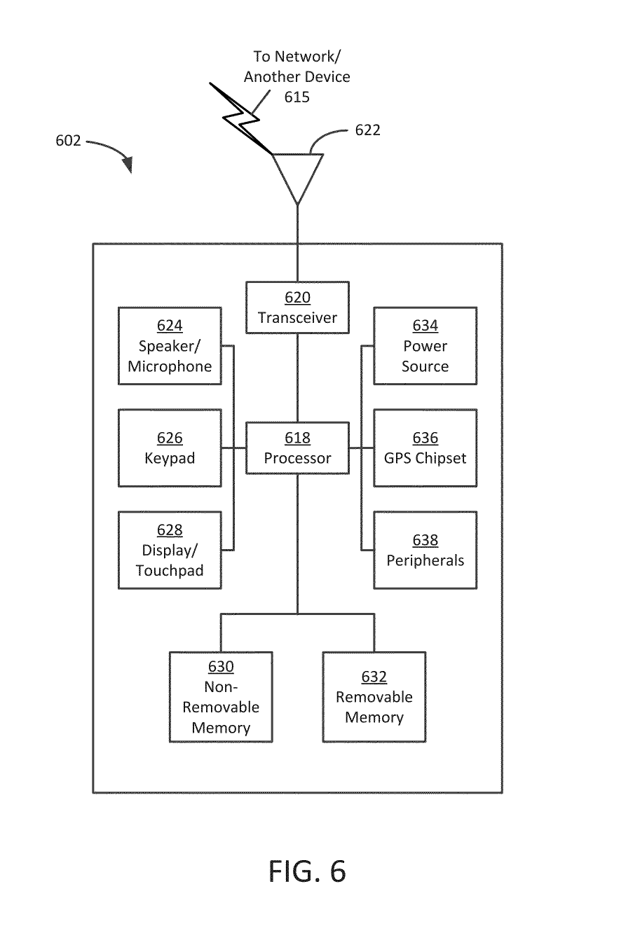

As described herein, the source 203 may include a device of a user (e.g., such as the WTRU 602 shown in FIG. 6 and/or the device/computing system 700 shown in FIG. 7) and/or websites visited by the user. In an example, the server 202 may collect (e.g., receive) information or data associated with the device and may use such information or data to generate a user profile. For example, the server 202 may access the device of a user to acquire (e.g., receive) additional data or information that may be representative of a user's current activity. Such data or information may include like IP addresses 216 that may have been used or recently used on the device, specifications or content 218 of or on the device or devices used by the user device(s) including, for example, photographs, cached content, device settings, and/or the like, one or more email addresses 220 associated with the user, one or more applications 22 that may be installed on the device including the content thereof, and/or any other suitable information or data that may be indicative of preferences of a user of the device. As described herein, the data or information from the device may be used to generate a user profile and/or a score or points associated therewith such that one or more advertisements or coupons may be delivered using the profile and/or score or points.

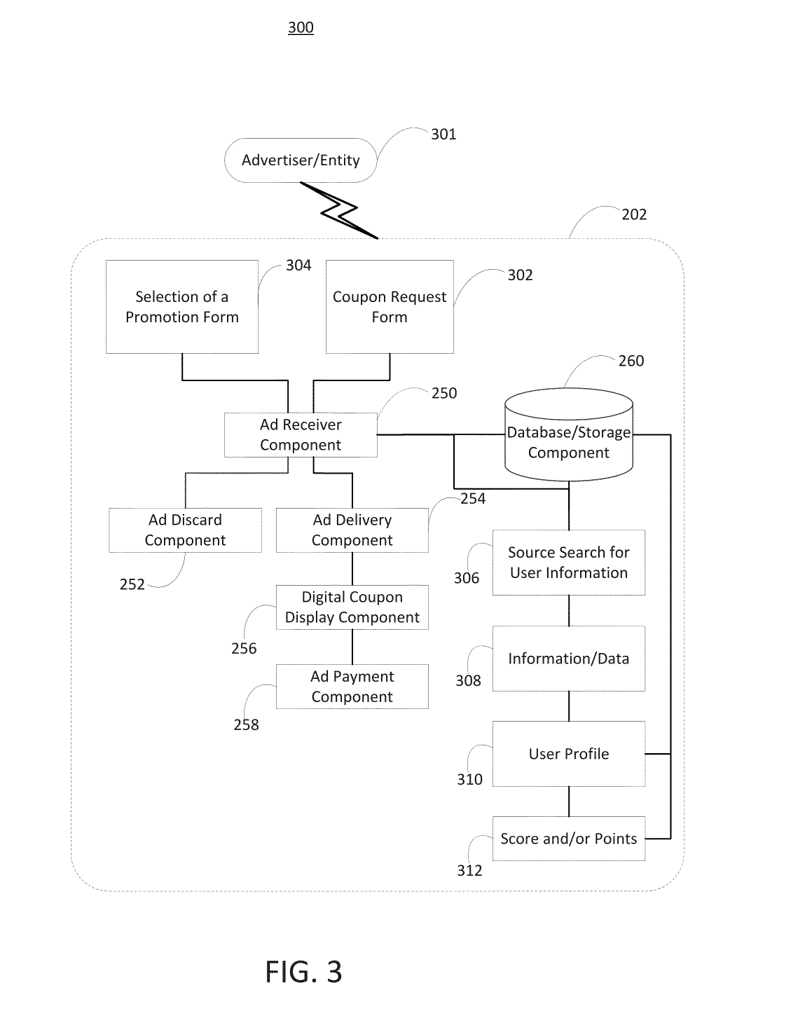

FIG. 3 illustrates a diagram of an example system and/or method 300 such as method that may be used by the server 202 of FIG. 2 and/or another device to create an advertisement or coupon as described herein. For example, an advertiser or entity 301 that may be in communication with the server may create data or information that it may wish to be used for an advertisement or coupon campaign using the server 202. As shown in FIG. 3, a coupon request form 302 may be provided and/or a selection of a form of promotion (e.g., a promotion form) 304 associated with the coupon request form may be received. For example, the coupon request form 302 may be an advertising form that may offer a 50% discounts on dinners for the first 50 requests. The adverting form may include a graphic field to recover email and name and surname from a user. The user may fill out the form and send it back to the server 202. The server 202 may receive the information or data from the form and may determine a name, surname, email address, and/or the like therefrom. The server 202 may scan for the name, surname and email address on sources such as one or more social network and websites. In an example, the server 202 may find or determine that the email address and the name may be on one or more sources or websites (e.g., the email address and/or name may be verified). In such an example, the server 202 may receive from an advertisement server information associated with the advertisement and the advertisement may be delivered to the user. In an example, the advertisement may be delivered based on a score associated with a user profile (e.g., that may be generated based on and may include the email address and/or that may have points associated therewith to generate the score as described herein). The user profile (e.g., the email address and/or name that may be included therein) may not be found on one or more sources or websites. In such an example, the advertisement server may be configured (e.g., by an administrator) to not deliver advertisements as the user profile may not be found during the scan.

For example, the server 202 may include the coupon request form 302 and/or the form of promotion 304. The server 202 may provide the form of promotion 304 to the advertiser or entity 301. The advertiser or entity 301 may input data and/or select a format for the campaign using the form 304 and/or the coupon request form 302 that may also be provided to a user. Such a selection and/or data from the advertiser or entity 301 may be received by the server 202 (e.g., via an advertisement receiver component 250 that may be included in the server 202).

In an additional example, the advertiser 301 may build or generate the digital coupon request form and/or select a form of promotion that may be used to publish a corresponding coupon request form to a user and may send such forms and data to the server 202 to be received thereby. Using the coupon request form and/or promotion form for the same, the advertiser or entity 301 may create advertisement or coupon data for a campaign. For example, the advertiser or entity 301 may create an advertisement or coupon on the server 202 with the form of promotion 304. The coupon request form 302 associated therewith may then be distributed by the server 202 to a user (e.g., via an advertisement delivery component 254).

For example, a user may be searching for digital coupons and may be interested in receiving special offers. The coupon request form 304 may be provided to the user (e.g., by the server 202). Such a form may be filled out and submitted by a user such that it may further be received by the server 202 through the advertisement receiver component 250. As shown in FIG. 3, the advertisement receiver component 250 may be in communication with or connected to a database or storage component 260 (e.g., that may be or may be similar to the storage component 775 of FIG. 7).

The server 202 may retrieve data or information about the user from the database or storage component 260. As described herein, the server 202 may also perform a search 306 for additional information on a source such as a social network as described herein. According to an example, the database or storage component 260 may include a user profile for the user that may have submitted the coupon request form 302. In such an example, the user profile in the database or storage component 260 may be updated. In an example, the server 202 may update data and/or information periodically. For example a server such as the server 202 may scan information or data for existing profiles once a week, once a day, once a month, and/or the like. The server 202 may scan again and the data or information may match the information or data from a previous scan and/or may include new information or data. For example, a user may have additional friends, pictures, and/or the like in a subsequent scan. The score may be updated based on the additional friends, pictures, and/or the like. For example, if the profile may have additional friends, pictures, and/or the like, the score may be updated and adjusted such that a potential coupon request form may have the same advertisement response (e.g., may provide the same coupon) or a different one depending on the recovered information or data and/or the score associated therewith.

The server 202 may include an advertisement deliver component 254. In an example (e.g., upon updating the user profile based on the coupon request form received from the user), the server 202 may engage the advertisement delivery component 254. The advertisement delivery component 254 may invoke a digital coupon component 256 that may be included in the advertisement deliver component 254 and/or may be a separate component to render a digital coupon. The digital coupon may be provided to the user such that it may be displayed thereto (e.g., using the digital coupon component 256).

The server 202 may include an advertisement payment component 258. The advertisement payment component 258 may include components that may communicate with a payment processor that may be used to resolve or handle a transaction or payment for the digital coupon delivery or distribution and/or may include components to process the payment for the digital coupon deliver or distribution itself. Thus, in an example, the advertisement payment component 258 may include an interface to a payment processor that may be used to resolve a payment transaction for the delivery or distribution of the digital coupon and/or may be a payment processor that may resolve the payment transaction for the delivery or distribution of the digital coupon. As such, the advertiser or entity 301 may pay for the delivery or distribution of the digital coupon using the advertisement payment component 258.

In an example, the database or storage component 260 may not include a user profile for the user that may have submitted the coupon request form 302. In such an example (e.g., If, a user profile for a user that may have submitted the coupon request form 302 may not be yet included in the database or storage component 360), the server 202 may invoke a search 306 on a source such as asocial network, a device of the user, and/or the like as described herein. Information or data 308 from the source about the user as described herein (e.g., in response to the search 306) may be received and/or gathered by the server 202. A user profile 310 may be generated based on the data or information 308 that may have been gathered or received. For example, the server 202 may generate a user profile that may include or based on the information or data. According to an example, the profile may be generated if or when a profile with or based on the information or data may not already be included in the database such that the server may invoke a scan or search on sources and may receive or gather the information or data from the sources to generate the profile as described herein. The profile may be generated with a lower score or not generated depending on whether information or data may be gathered or not. For example, if no information or data may be gathered, the profile may be generated with a very low score or may not be created (e.g., depending on the settings or administrator's configuration.) In an example, a score or points 312 associated with the user profile and/or the information or data that it may be generated based on. For example, the server 202 may calculate a score or points associated with the user as described herein (e.g., a profile or information nor data associated therewith may be recovered, points may be assigned thereto, and a score may be determined or calculated based thereon). The user profile 310 and/or score or points 312 associated therewith may be stored in the database or storage component 260.

As described herein, storing the user profile and/or the score or points, for example, may enable sensitive information to be used by the server 202 and/or an advertiser or entity 301 to deliver or distribute a digital coupon or advertisement, for example, by using such information or data to generate the user profile and/or the score or points associated therewith without compromising the sensitive information or data by saving the actual information or data.

As described herein, the server 202 may engage the advertisement delivery component 254 (e.g., upon saving the profile and/or score or points), the digital coupon display component 256 to send or display the coupon to the user, and/or the advertisement payment component 258 to receive payment for the delivery or distribution of the coupon or advertisement. According to an example, the advertisement delivery component 254 may deliver the coupon or advertisement based on the user profile and/or the score or points associated therewith. For example, different offers or coupons may be delivered to a user based on the user profile and/or the score associated therewith. In particular, in an example, if a first score may be associated with a user profile, a first coupon that may include an offer for a discount of 50% off of dinner. Further, according to an example, if a second score (e.g., that may be higher than the first score) may be associated with a user profile, a second coupon that may include the discount of 50% off dinner and a priority for a reservation for the dinner that may be assigned by the advertiser. As such, a higher score may result in additional coupon offers (e.g., the second coupon may include additional offers that man not be included in the first coupon) and/or the server may have different offers on different scores for the profiles generated.

In an example, the advertisement or coupon may not be delivered. For example, the server 202 may include an advertisement discard component 252. The advertisement discard component 252 may discard data or information such as the information or data received from the user and/or the advertiser or entity 301. In an example, the data or information may be discarded by the advertisement discard component 252 if or when the server 202 may fail to generate a user profile, if or when there may not be suitable data or information no useful data associated with the user, the user may cancel the request, and/or under any other criteria or condition.

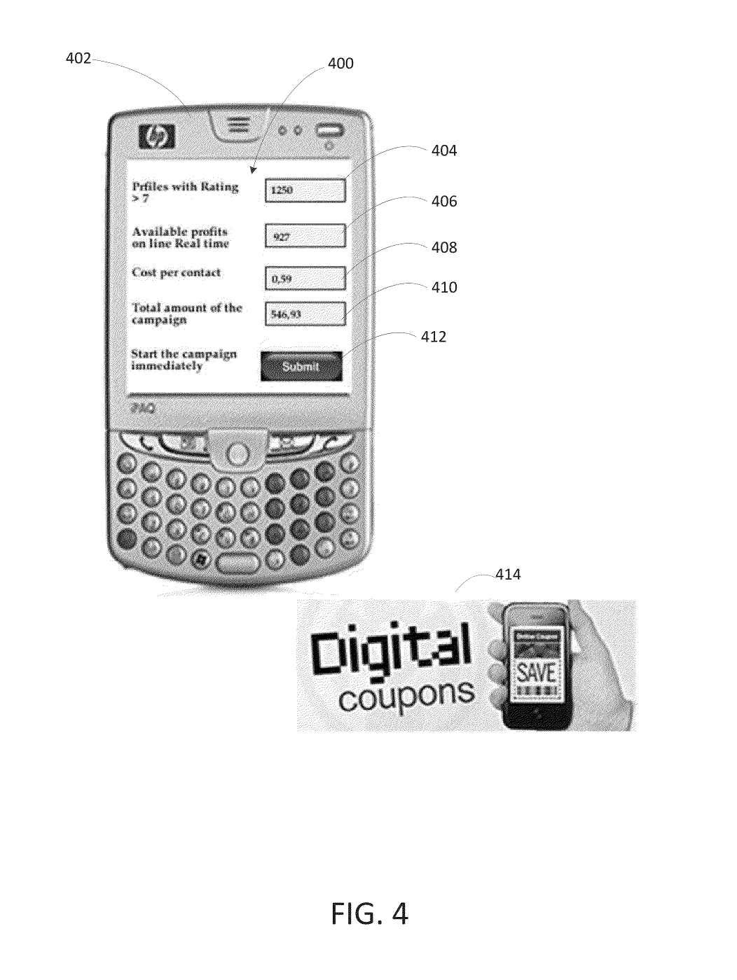

FIG. 4 illustrate an example of interface or form 400 (e.g., the form of promotion or promotion form 304 of FIG. 3) that may be used to initiate delivery or distribution of a coupon or advertisement 414. As shown in FIG. 4, a device 402 (e.g., that may be the same or similar to the device or WTRU 602 in FIG. 6) may provide or display the form or interface 400. An advertiser or entity may interact with the interface or form 400 to set up distribution or delivery of a coupon or advertisement using the server such as the server 202.

For example, an advertiser or entity that may offer coupons or discounts may use the device 402 to connect to the interface or form 400. The advertiser or entity may search for user profiles with a particular rating via 404 of the interface or form 400 and/or the server may provide the interface or form with the number of user profiles with a particular rating via 404 (e.g., automatically or without a search being performed by the advertiser or entity). The device 402 may receive, for example, in real time from the server, a number of contacts available for the particular rating and/or and may display the same via 406. In an example, a contact or the number of contracts may represent the number of profiles that may match with a specification of or provided by the advertiser. The form or interface 400 may provide a cost per contact per view of the digital coupons 408, a total investment 410 that the advertiser or entity may provide to use the server to deliver or distribute the coupons or advertisements, for example, to a user with the ratings, and an option 412 to start the campaign that may be selected by the advertiser or entity to initiate delivery or distribution of coupons or advertisements to a user based on the information in the form or interface 400 (e.g., in response a coupon deliver request form by a user and/or automatically to a user without receipt of a coupon delivery request form). A coupon or advertisement 414 may be distributed or deliver to a device of a user as described herein (e.g., in response to initiation of the campaign by selecting the option 412 on the form or interface 400).

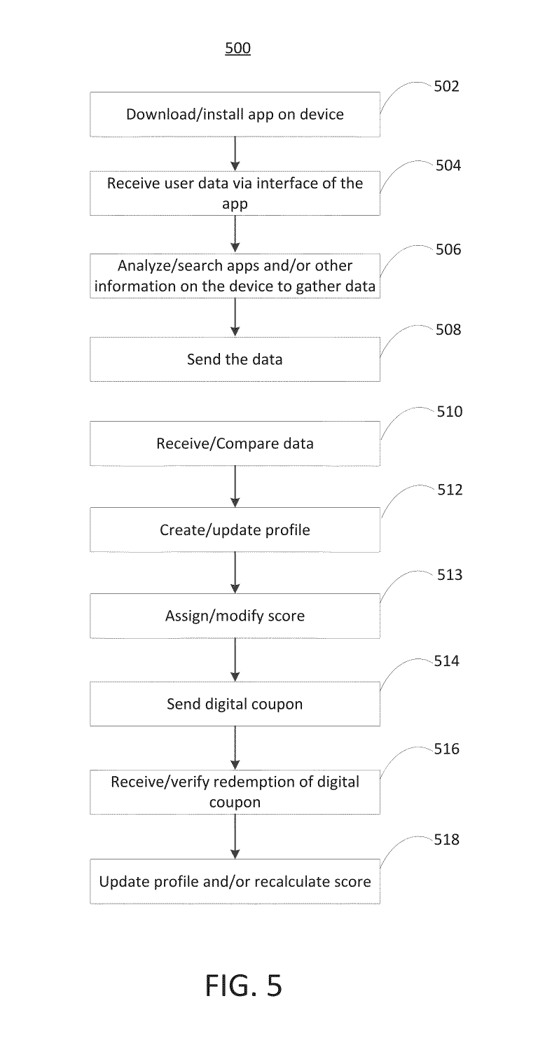

FIG. 5 illustrates an example method 500 for enabling a user to receive coupons and/or discounts as described herein. As shown in FIG. 5, at 502, an application may be downloaded and/or installed on a device such as the device or WTRU 602 shown in FIG. 6 to enable or allow a user to receive discounts and/or coupons. For example, a user may interact with his or her device such that the device may download and install an application, at 502, that may be provided by a server such as the server 202 and/or an advertiser or entity such as the advertiser or entity 301. According to an example, the application may be downloaded on the device directly from the server and/or advertiser or entity, indirectly from an application store that may provide applications for the device, and/or using any other suitable technique.

The application and, thus, device may receive information or data about the user via an interface of the application at 504. For example, in an embodiment, the user may enter data or information into the application via an interface (e.g., a user interface) thereof. In an example, the interface may be provided on a display of the device (e.g., the interface may be rendered, output or displayed to the user on the device such that the user may enter information in the interface). Such information or data may be received at 504.

Additionally, the application that may be installed on the device may track a user's behavior or interaction with the device or characteristics, properties, and/or the like of the device such that the application may collect and/or gather information or data about the user that may be indicative of his or her lifestyle, preferences, tastes, and/or the like at 506. For example, the application may search over the other applications on the device (e.g., including a browser, a social network application, a device settings application, and/or the like) for the information or data that may be used to create a user profile. Such data may be gathered or collected (e.g., received) at 506.

The device, for example, via the application may provide or send the information or data at 508. For example, the device may send the information or data that may be received from a user and/or gathered or collected by searching other applications to the server, at 508, such that the server may collect and/or gather (e.g., receive at 510) the data or information for generation of a user profile and/or score or points associated therewith.

In an example, the data or information received from the device and/or application thereon may be processed (e.g., after being sent at 508). For example, at 510, the data or information may be received by the server. The data or information may also be compared at 510. For example, at 510, the server may compare the data or information collected by the device and application as described herein to the user profiles including the data or information associated therewith that may already present in the database or storage component. For example, data or information may be recovered or received from the application at the server. The data or information may be compared with profiles in the database to determine whether a profile may exist or not for the user. In an example, if a profile with such name and or specification may already found, the data or information received or recovered may be compared with the information or data associated with the profile in the database to verify whether there may be a match or not (e.g., whether they may match or if they may be different). As described herein, the database may include the data or information previously recovered or received and/or a score generated based thereon. The additional data or information recovered or received may be used to update the profile and/or the score.

A user profile may be created and/or updated as described herein, at 512. For example, a user profile for the user from which the data or information may have been gathered or collected (e.g., and received) may not exist in the server (e.g., may not be in the storage component or database thereof). As such, this may be the first time or interaction of the user with the server and/or the application on his or her device. In such an example, the data or information gathered or collected that may be received, at 510, and collected as described herein may be used to create a user profile for the user and/or a score or points associated therewith as described herein at 512.

Further, a user profile for the user from which the data or information may have been gathered or collected (e.g., and received) may already exist in the server (e.g., may already be in the database or storage component thereof). As such, this may be an additional interaction of the user with the server and/or the application on his or her device. In such an example, the information or data gathered or collected that may be received, at 510, may be used to modify and/or update the user profile at 512. As described herein, in examples, the profile may be updated and modified by comparing or checking data or information previously received or recovered with additional data or information received. Additional points may be assigned to the information or data in the profile and/or the score may be updated to reflect those points. For example, additional points may be assigned to the profile and/or the score updated as the additional information or data may be more accurate (e.g., the additional information may include geolocation, personal data or information, and/or the like that may be more accurate than the previous information or data the user profile and/or score may be based on).

The user profile that may be created or updated, at 512, may have a score or points that may be assigned and/or modified at 513. The user profile that may be created or updated, at 510, may or may not have a score or points associated therewith and the score or points may be assigned and/or modified at 513. For example, the user profile may not be included in the server (e.g., may not be included in the database or storage component) as described herein. In such an example, a score or points may not be associated with the user profile. As such, as described herein, score or points may be generated and assigned thereto based on the information or data at 513. In an example, the profile (e.g., including the points or scores associated therewith) may be updated or created by determining or assigning points to information or data associated with the profile based on settings, configurations, or specifications (e.g., the administrator may assign values or points to particular pieces of information or data that may make up the profile). As described herein, a list of data or information may be provided and may have a particular number of points associated therewith. The list may be used to determine points for information or data that maybe recovered or received in a scan. A score may be calculated or generated based on the points as described herein. Further, in an example, the more data or information that may be recovered the more points may be assigned and/or the more accurate the profile may be or may be determined to be. According to examples, the data or information may include or may be personal information, pictures, number of likes, a numbers of pictures, instruction, tastes, economical information, a bad reputation found on websites, a frequent user that may revoke on line purchasing, a bad credit score, a good credit score, and/or the like. Further, the user profile may be included in the server (e.g., may be included in the database or storage component). In such an example, a score or points may already be associated with the user profile. Such a score or points already associated with the user profile may be updated based on the information or data at 513. Digital coupons or advertisements may be sent at 514. For example, based on the user profile and/or score or points associated therewith, the server may send or distribute digital coupons or advertisements to the user via his or her device at 514.

At 516, an indication that the coupon or advertisement may have been redeemed may be received and verified. For example, the user may redeem a coupon or advertisement that may be sent at 514 at a retailer or goods or services provider. An indication that the coupon or advertisement may have been redeemed by the user may be received by the server at 516 (e.g., from his or her device via the application and/or via the retailer or goods or services provider). The server may then verify redemption of the digital coupon or advertisement at 516. In an example, the redemption may be verified as server tracks the interaction with and advertiser server. For example, if a user may recover or use the digital coupon, may send a form, may send a feedback, or may perform an action with the coupon, redemption may be tracked based thereon. The retailer may also include or use scripts to add on its site such that tracking may be securely registered.

In an example, based on the verification, the score or points may be recalculated and the user profile may be updated at 518. For example, a higher score may be calculated for a particular good based on redemption (e.g., when redemption may occur for the good at the retailer more points may be assigned and/or a higher score may be calculated or generated). As such, in an example, the server (or system) may assign points on each purchase that may be made for a profile. The profile may be more reliable and of higher interest to an advertiser based on the number of purchases (i.e., if the number of purchases may be higher than other users or other profiles or a threshold associated therewith). As such, the higher the number of purchases, the greater the number of points may be assigned to a profile or information or data associated therewith and the higher the score (e.g., the more reliable the profile may be).

Additionally, although an action or functionality of FIGS. 1-5 may be shown to be performed by a particular entity such as the server, the application, and/or the device, it may be appreciated that such actions or functionalities may be performed by other entities described herein. For example, the server may perform functionalities or actions of the device and/or application, the application may perform functionalities of the device and/or server, and the device may perform functionalities of the application and/or server. As an example, the application and/or device may receive and/or compare the data or information at 510, may create and/or update a profile at 512, may assign and/or modify a score or points at 513, may send a digital coupon to a display component of the device at 514, and/or may receive an indication of redemption of the coupon and/or verify such a redemption at 516.

FIG. 6 depicts a system diagram of an example device such as a WTRU 602 that may be used to execute an application or instructions therefore for collecting and/or gathering data or information and/or providing digital coupons as described herein. For example, the WTRU 602 may be used to implement the systems and methods described herein including the server and/or devices described herein and may execute a variety of computing applications (e.g., that may include the methods 100-500 of FIGS. 1-5 described herein or functionality thereof). As shown in FIG. 6, the WTRU 602 may include a processor 618, a transceiver 620, a transmit/receive element 622, a speaker/microphone 624, a keypad 626, a display/touchpad 628, non-removable memory 630, removable memory 632, a power source 634, a global positioning system (GPS) chipset 636, and other peripherals 638. It may be appreciated that the WTRU 602 may include any sub-combination of the foregoing elements while remaining consistent with an embodiment. Also, embodiments contemplate that other devices and/or servers or systems described herein, may include some or all of the elements depicted in FIG. 6 and described herein.

The processor 618 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 618 may perform signal coding, data processing, power control, input/output processing, and/or any other functionality that may enable the WTRU 602 to operate in a wireless environment. The processor 618 may be coupled to the transceiver 620, which may be coupled to the transmit/receive element 622. While FIG. 6 depicts the processor 618 and the transceiver 620 as separate components, it may be appreciated that the processor 618 and the transceiver 620 may be integrated together in an electronic package or chip.

The transmit/receive element 622 may be configured to transmit signals to, or receive signals from, another device (e.g., the user's device and/or a network component such as a base station, access point, or other component in a wireless network) over an air interface 615. For example, in one embodiment, the transmit/receive element 622 may be an antenna configured to transmit and/or receive RF signals. In another or additional embodiment, the transmit/receive element 622 may be an emitter/detector configured to transmit and/or receive IR, UV, or visible light signals, for example. In yet another or additional embodiment, the transmit/receive element 622 may be configured to transmit and receive both RF and light signals. It may be appreciated that the transmit/receive element 622 may be configured to transmit and/or receive any combination of wireless signals (e.g., Bluetooth, WiFi, and/or the like).

In addition, although the transmit/receive element 622 is depicted in FIG. 6 as a single element, the WTRU 602 may include any number of transmit/receive elements 622. More specifically, the WTRU 602 may employ MIMO technology. Thus, in one embodiment, the WTRU 602 may include two or more transmit/receive elements 622 (e.g., multiple antennas) for transmitting and receiving wireless signals over the air interface 615.

The transceiver 620 may be configured to modulate the signals that are to be transmitted by the transmit/receive element 622 and to demodulate the signals that are received by the transmit/receive element 622. As noted above, the WTRU 102 may have multi-mode capabilities. Thus, the transceiver 620 may include multiple transceivers for enabling the WTRU 602 to communicate via multiple RATs, such as UTRA and IEEE 802.11, for example.

The processor 618 of the WTRU 602 may be coupled to, and may receive user input data from, the speaker/microphone 624, the keypad 626, and/or the display/touchpad 628 (e.g., a liquid crystal display (LCD) display unit or organic light-emitting diode (OLED) display unit). The processor 618 may also output user data to the speaker/microphone 624, the keypad 626, and/or the display/touchpad 628. In addition, the processor 618 may access information from, and store data in, any type of suitable memory, such as the non-removable memory 630 and/or the removable memory 632. The non-removable memory 630 may include random-access memory (RAM), read-only memory (ROM), a hard disk, or any other type of memory storage device. The removable memory 632 may include a subscriber identity module (SIM) card, a memory stick, a secure digital (SD) memory card, and the like. In other embodiments, the processor 618 may access information from, and store data in, memory that is not physically located on the WTRU 602, such as on a server or a home computer (not shown). The removable memory 630 and/or non-removable memory 632 may store a user profile or other information associated therewith that may be used as described herein.

The processor 618 may receive power from the power source 634, and may be configured to distribute and/or control the power to the other components in the WTRU 602. The power source 634 may be any suitable device for powering the WTRU 602. For example, the power source 634 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 618 may also be coupled to the GPS chipset 636, which may be configured to provide location information (e.g., longitude and latitude) regarding the current location of the WTRU 602. In addition to, or in lieu of, the information from the GPS chipset 636, the WTRU 102 may receive location information over the air interface 615 from another device or network component and/or determine its location based on the timing of the signals being received from two or more nearby network components. It will be appreciated that the WTRU 602 may acquire location information by way of any suitable location-determination method while remaining consistent with an embodiment.

The processor 618 may further be coupled to other peripherals 638, which may include one or more software and/or hardware modules that provide additional features, functionality and/or wired or wireless connectivity. For example, the peripherals 638 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 7 depicts a block diagram of an example device or computing system 700 that may be used to implement the systems and methods described herein. For example, the device or computing system 700 may be used as the server and/or devices described herein. The device or computing system 700 may be capable of executing a variety of computing applications 780 (e.g., that may include the methods 100-500 of FIGS. 1-5 described herein or functionality thereof). The computing applications 780 may be stored in a storage component 775 (and/or RAM or ROM described herein). The computing application 780 may include a computing application, a computing applet, a computing program and other instruction set operative on the computing system 700 to perform at least one function, operation, and/or procedure as described herein. According to an example, the computing applications may include the methods and/or applications described herein. The device or computing system 700 may be controlled primarily by computer readable instructions that may be in the form of software. The computer readable instructions may include instructions for the computing system 700 for storing and accessing the computer readable instructions themselves. Such software may be executed within a processor 610 such as a central processing unit (CPU) and/or other processors such as a co-processor to cause the device or computing system 700 to perform the processes or functions associated therewith. In many known computer servers, workstations, personal computers, or the like, the processor 710 may be implemented by micro-electronic chips CPUs called microprocessors.

In operation, the processor 710 may fetch, decode, and/or execute instructions and may transfer information to and from other resources via an interface 705 such as a main data-transfer path or a system bus. Such an interface or system bus may connect the components in the device or computing system 700 and may define the medium for data exchange. The device or computing system 700 may further include memory devices coupled to the interface 705. According to an example embodiment, the memory devices may include a random access memory (RAM) 725 and read only memory (ROM) 730. The RAM 725 and ROM 730 may include circuitry that allows information to be stored and retrieved. In one embodiment, the ROM 730 may include stored data that cannot be modified. Additionally, data stored in the RAM 725 typically may be read or changed by the processor 710 or other hardware devices. Access to the RAM 725 and/or ROM 730 may be controlled by a memory controller 720. The memory controller 720 may provide an address translation function that translates virtual addresses into physical addresses as instructions are executed.

In addition, the device or computing system 700 may include a peripherals controller 635 that may be responsible for communicating instructions from the processor 710 to peripherals such as a printer, a keypad or keyboard, a mouse, and a storage component. The device or computing system 700 may further include a display and display controller 765 (e.g., the display may be controlled by a display controller). The display/display controller 765 may be used to display visual output generated by the device or computing system 700. Such visual output may include text, graphics, animated graphics, video, or the like. The display controller associated with the display (e.g., shown in combination as 765 but may be separate components) may include electronic components that generate a video signal that may be sent to the display. Further, the computing system 700 may include a network interface or controller 770 (e.g., a network adapter) that may be used to connect the computing system 700 to an external communication network and/or other devices (not shown).

Although the terms device, UE, or WTRU may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for providing digital coupons, the method comprising:
applying, at a server, settings for collecting or gathering data;
connecting, at the server, to a source based on the settings;
receiving, at the server, data for a user from the source;
generating, at the server, a user profile and a score associated therewith based on the data received; and
sending, from the server, a digital coupon to the user based on the user profile and the score associated therewith.

2. The method of claim 1, wherein the data comprises sensitive data.

3. The method of claim 2, further comprising discarding the sensitive data after generating the user profile.

4. The method of claim 3, further comprising sending at least one of the following to an advertiser associated with a digital coupon: the user profile, the score, or the data.

5. The method of claim 4, wherein the data sent does not include the sensitive data discarded.

6. The method of claim 1, wherein the source comprises at least one of the following: a social network, a device associated with the user, one or more applications used by the user, archived data about the user, or one or more websites visited by the user.

7. The method of claim 1, wherein the data further comprises data entered by the user.

8. The method of claim 1, wherein generating the user profile comprises recovering one or more the following: personal identification, geolocation information, social information, economic information, credit information, a number of social network subscribed, picture information, video information, friend information, or search engine popularity that is included in the user profile.

9. The method of claim 1, wherein generating the score associated with the user profile comprises:
assigning corresponding numerical values to characteristics of the user profile defined by the data or information; and
calculating a sum of the numerical values to generate the score.

10. The method of claim 1, wherein the data or information associated with the user comprises additional information or data associated with the user, and wherein the method further comprises updating the user profile and the score associated therewith based on the additional data or information associated with the user.

11. A device comprising an application, at least one of the device or application configured at least in part to:
render an interface to a user, the interface being configured to receive data from the user;
receive the data from the user received via the interface;
track additional data associated with the user, the additional data being indicative of one or more characteristics or preferences of the user tracked based on one or more of the following: interactions on the device, applications on the device, or data or information on the device or used by the device; and
send the data and additional data to receive a digital coupon based on the data and additional data.

12. The device of claim 11, wherein at least one of the device or application is further configured at least in part to receive, from a server, the digital coupon.

13. The device of claim 12, wherein the data and additional data is used to generate a user profile for the user and a score associated with therewith, and wherein the digital coupon is received based on one of the following: the user profile or the score.

14. The device of claim 13, wherein at least one of the device or application is further configured at least in part to:
compare the data and additional data with user profiles already generated;
create the user profile when a user profile associated with the data or additional data does not already exits; and
calculate the score associated with the created user profile.

15. The device of claim 14, wherein at least one of the device or application is further configured at least in part to:
update the user profile when a user profile associated with the data or additional data does not already exist; and
recalculate the score associated with the updated user profile.

16. The device of claim 14, wherein at least one of the device or application is further configured at least in part to:
receive an indication that the digital coupon has been redeemed;
verify redemption of the digital coupon;
update the user profile based on the redemption of the digital coupon being verified; and
recalculate the score associated with the updated user profile.

17. The device of claim 14, wherein at least one of the device or application is further configured at least in part to calculate the score by assigning corresponding numerical value to characteristics of the user profile defined by the data or additional data; and calculating a sum of the numerical values to determine the score.

18. A server, the server configured at least in part to:
receive data and additional data, the data comprising data received from an input by a user and the additional data comprising data tracked on a device of the user, the additional data being indicative of one or more characteristics or preferences of the user determined based on one or more of the following: interactions on the device, applications on the device, data or information on the device or used by the device;
compare the data and additional data with user profiles already generated;
create a user profile when, based on the comparison, the data or additional data is not associated with user profiles that already exist;
calculate a score associated with the created user profile; and
send a digital coupon based on the user profile and the score.

19. The server of claim 18, wherein the server is further configured to:
receive an indication that the digital coupon has been redeemed;
verify redemption of the digital coupon;
update the user profile based on the redemption of the digital coupon being verified; and
recalculate the score associated with the updated user profile.

20. The server of claim 18, wherein server is further configured at least in part to calculate the score by assigning corresponding numerical values to characteristics of the user profile defined by the data or additional data; and calculating a sum of the numerical values to determine the score.
